(19) United States
(12) Patent Application Publication
(10) Pub. No.: US 2006/0212847 A1
(43) Pub. Date: Sep. 21, 2006

(54) Type checker for a typed intermediate representation of object-oriented languages

(75) Inventors: David Read Tarditi JR., Kirkland, WA (US); Juan Chen, Sammamish, WA (US)

Correspondence Address: KLARQUIST SPARKMAN LLP, 121 S.W. SALMON STREET, SUITE 1600, PORTLAND, OR, 97204, US

(73) Assignee: Microsoft Corporation, Redmond, WA (US)

(21) Appl. No.: 11/084,374

(22) Filed: Mar. 18, 2005

(51) Int. Cl. G06F 9/44

(52) U.S. Cl. 717/117

(57) ABSTRACT

Described herein are methods and systems for applying typing rules for type checking typed intermediate representations of computer program whose source code was written in an object-oriented language. The typing rules are decidable in part because the typed intermediate representation retains class name-based information related to classes from the source code representation. The class name-based information includes information related to class hierarchies, which in part can be used to express sub-classing. Typing rules are applied to parts of the intermediate representation that are typed based on class name-based types and the corresponding structure-based record types. Thus, some typing rules are described herein that are based on sub-classing bounds of type variables. The typing rules include rules related to method calls including type arguments, coercions, existential type operations such as, open and pack.

### TECHNICAL FIELD

The field relates to verifying the safety of computer program code. More particularly, the field relates to a type checker for type checking typed intermediate language representations of computer programs.

### BACKGROUND

Compilers transform programs from high-level programming languages to machine code by a series of steps. At each stage in compilation, an intermediate language can be defined to represent programs at that stage. At each new stage, the corresponding intermediate language representation exposes more details of the computation than the previous stage up to the point where machine code is reached. Maintaining information regarding types within such intermediate representations has significant benefits. For instance, a typed intermediate language allows intermediate program representations to be type-checked and thus, can be used to debug compilers, to guide optimizations, and to generate safety proofs for programs. Furthermore, typed intermediate representations can be used as a format for redistributing programs. Thus, a user can (mechanically) check that the program redistributed in the intermediate form is safe to run, as opposed to relying on certificates or third party claims of trustworthiness.

In practice, however, compilers for object-oriented languages do not maintain enough type information in low-level intermediate representations so that programs in those representations can be typechecked, even though their input is statically typed. One reason, compilers for object-oriented languages have failed to adopt compilation using typed intermediate representations is the complexity related to the traditional class and object encodings used in previous approaches to obtaining typed intermediate representations for object-oriented languages. A great deal of work has been done for developing typed intermediate languages for functional languages, but much of this work does not support object-oriented programming languages, which are widely used in practice (e.g., C#, C++, and Java). Thus far, those typed intermediate languages that have been proposed for object-oriented languages are complicated, often inefficient, and do not allow compilers to use standard implementation techniques. In short, they are not suitable for practical compilers.

A typed intermediate representation will maintain type information related to components of the intermediate language representation, such as expressions, declarations, and statements. The intermediate language representation is produced by translating a source code representation in an object-oriented language to the intermediate representation. Once a typed intermediate representation is generated a type checker is needed to type check the intermediate representation to ensure type safety of the intermediate representation of the program.

### SUMMARY

Described herein are methods and systems for evaluating type safety of computer programs in a typed intermediate language representation. In one aspect the typed intermediate representations are of computer programs written originally in an object-oriented programming language. In another aspect, at least one code portion of the typed intermediate representation comprises expressions, variables, statements, etc. that are typed based on class name-based types and the corresponding structure-based record types.

In yet another aspect, such a typed intermediate representation is type checked by applying typing rules based in part on the class name-based types and the corresponding structure-based record types.

According to another aspect, type checking such a low level intermediate representation is decidable in part because at least some of the typing rules are at least in part based on sub-classing bounds for type variables. In one further aspect, the typing rules for the exemplary typed intermediate representations comprise at least one rule connecting sub-classing of one or more class named-based types in the intermediate representation to sub-typing of one or more structure-based record types. Other rules include those related to coercions both from objects of class-name based types to records of structured-based types and ones from records of structure-based types to objects of class name-based types. In further aspects, typing rules include rules for open expressions, pack expressions and method calls based in part on sub-classing bounds for type variables in the typed intermediate representation.

Additional features and advantages will become apparent from the following detailed description of illustrated embodiments, which proceeds with reference to accompanying drawings.

### BRIEF DESCRIPTION OF THE DRAWINGS

FIG. 1 is a block diagram illustrating an exemplary system comprising a compiler generating a typed intermediate representation of a computer program from its source code representation in an object-oriented language and a type checker to ensure that the program, in its typed intermediate representation, is type safe.

FIG. 2 is a block diagram illustrating an exemplary form of classes in an exemplary typed intermediate representation of a computer program.

FIG. 3A is a block diagram illustrating a sub-classing relationship between classes of a source code representation in an object-oriented language.

FIG. 3B is a block diagram illustrating the loose use of class names in object-oriented languages to refer to the types of exemplary objects of related classes shown in FIG. 3A.

FIG. 4A is a block diagram illustrating a sub-classing relationship between classes in an exemplary typed intermediate representation of source code from an object-oriented language.

FIG. 4B is a block diagram illustrating the exemplary class names and record types of related classes as shown in FIG. 4A represented by precise class names in an exemplary typed intermediate representation of source code from an object-oriented language.

FIG. 5A is a block diagram illustrating an exemplary existential type that binds a type variable identifying the dynamic type of an object.

FIG. 5B is a block diagram illustrating an exemplary representation of an existential type that abstracts the dynamic type of objects in a typed intermediate representation and the corresponding record type that approximates the layout of the objects of the dynamic type.

FIG. 6 is a listing comprising at least some exemplary typing rules for at least some form of expressions in the exemplary typed intermediate representation.

FIG. 7 is a flow diagram illustrating an exemplary method for type checking a typed intermediate representation of a computer program compiled from its source code representation in an object-oriented language.

FIG. 8 is a diagram depicting a general-purpose computing device constituting an exemplary system for implementing the disclosed technology.

### DETAILED DESCRIPTION

### An Exemplary Type Checking System

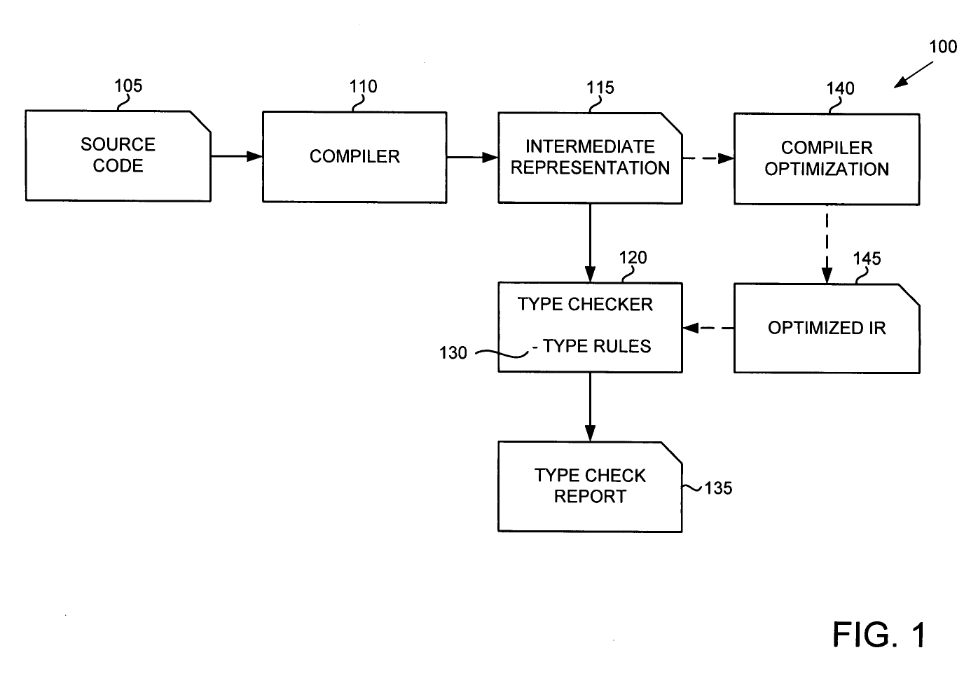

FIG. 1 illustrates an exemplary overall system 100 for evaluating the type safety of computer code. The system 100 comprises a compiler 110 for compiling a source code representation 105 in an object-oriented language to a corresponding typed intermediate representation 115. The system 100 further comprises a type checker 120, which performs type check analysis of the typed intermediate representation 115. The type check analysis performed by the type checker 120 is according to the type checking rules 130 which are applied to the typed intermediate representation 115. The result of the type checking evaluation may be expressed as a type check report 135. Among other things, the type check report 135 comprises answers to whether or not one or more portions of code in the intermediate representation 115 have violated one or more typing rules 130.

Alternatively, after an initial compilation from the original source code representation 105 to an intermediate representation 115, the compiler optimization processes 140 can be applied to the intermediate representation 115 to further streamline the original source code 105 according to particular target architectures, for instance. The dashed lines connecting optimizations 140 and optimized form 145 of the intermediate representation 115 to the type checker 120 simply indicate that optimizations 140 are not required to be applied to the intermediate representation 115 prior to type checking.

Nevertheless, applying the optimizations 140 results in an optimized form 145 of the intermediate representation 115, which too can be type checked by the type checker 120. Also, FIG. 1 shows a single intermediate representation 115. However, it is possible to have more than one intermediate representation, such as the one at 115 prior to lowering the program in question to its machine code representation. The principles of type checking including the exemplary typed intermediate representation described in additional detail below can be applied to any such intermediate representations and any number of such intermediate representations (e.g., 115 in FIG. 1).

### An Exemplary Overall Method of Type Checking

Programming models generally known as object-oriented programming provide many benefits that have been shown to increase programmers' productivity. In object-oriented programming, programs are written as a collection of classes each of which models real world or abstract items by combining data to represent the item's properties with functions to represent the item's functionality. More specifically, an object is an instance at runtime of a defined type referred to as a class, which among other things can exhibit the characteristics of data encapsulation, polymorphism and inheritance. Data encapsulation refers to the combining of data (also referred to as fields of an object) with methods that operate on the data (also referred to as member functions of an object) into a unitary software component (i.e., the class), such that the class hides its internal composition, structure and operation and exposes its functionality to client programs that utilize the class only through one or more interfaces. An interface of the class is a group of semantically related member functions of the class. In other words, the client programs do not access the object's data at runtime directly, but must instead call functions on the class's interfaces to operate on the data. Polymorphism refers to the ability to view (i.e., interact with) two similar classes through a common interface, thereby eliminating the need to differentiate between two classes. Inheritance refers to the derivation of different classes from a base class, where the derived classes inherit at least some of their properties and characteristics from the base class.

Source code representations of object-oriented language (e.g., C++, Java, or C#) classify expressions and other components of the source code representation based on the types of values that those expressions may have at runtime. The types include classes and/or other types such as primitive types. The classes may be of user-defined classes or built-in classes (e.g., string etc.). Expressions within the code may comprise variables of one or more classes.

A program is type-safe if, when the program is executed, an expression or other component of the source code representation that is classified as having a specific type, is guaranteed to only have values that are of that type. For example, we may wish to ensure that an integer is never passed at runtime as an argument to a function that expects a string. To ensure the type safety of the program as a whole, the type safety of the sub-expressions and operations within should be checked.

As an example, suppose a computer program has code that declares variables X and Y as integers. Further suppose that there is a typing rule (e.g., 130 in FIG. 1) that sets forth that expressions such as e₁: Z=X+Y should be of type integer, if X and Y are of type integer. A type checker 120 will apply the rule as noted above to evaluate the type safety of the expressions, such as e₁ to ensure type safety of the program as a whole. However, to ensure type safety of selected portions of code, it follows that the code should have a system of typing components of the code and rules (e.g., 130) that can be applied to the code portions.

Thus, to check the type safety of code in an intermediate representation requires a system of typing components of the code in the intermediate representation. In fact, without a typed intermediate representation 115, verifying that optimizations 140 and other operation performed on the intermediate representation 115 do not violate type safety would be difficult and, in some cases, create unwanted overhead during runtime. Described in further detail below, is a typed intermediate representation for source code in an object-oriented language, wherein the notions of class name, class name-based hierarchies and other class name-based information related to the classes defined in the source code representation are retained in the intermediate representation (e.g., 115). The typing rules (e.g., 130) too, in part, can be expressed in form of constructs in a typed intermediate language that preserves the notions of class names and class hierarchies declared in the source code representation 105.

### An Exemplary Intermediate Representation of Classes in a Typed Intermediate Representation

One way to make type checking of typed intermediate representations, such as 115 (FIG. 1), decidable (e.g., 120) is to allow lightweight notions of class names and any hierarchical relationships declared in a source code representation 105 to be preserved in the typed intermediate representation 115 (FIG. 1) instead of discarding them during compilation, while also adding structure-based information related to the class, such as a class's layout. Among other things, this approach enables the type checking of such intermediate representations 115 (FIG. 1) to be decidable.

Retaining the class name-based information of classes of the source code representation allows a compiler to express name-based sub-classing relationships of classes in the intermediate representation for type checking purposes. Furthermore, such sub-classing relationships based on class names can then be expressed separately from the structure-based sub-typing relationships. Among other things, expressing sub-classing relationships and hierarchies in a name-based form simplifies the process of type checking at compile time because in-part, bounds for applying type checking rules expressed in terms of name-based sub-classing relationships are decidable unlike the rules that rely on structure-based sub-typing relationships alone.

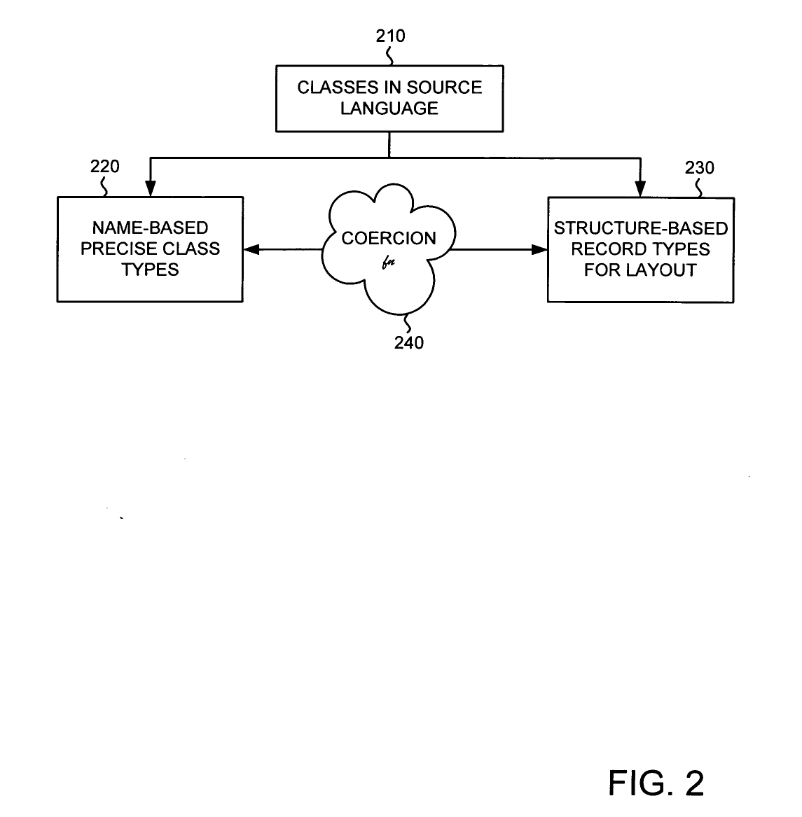

FIG. 2 illustrates this concept of retaining class name-based information for expressing classes in an intermediate representation, which can be expressed independently of the related structure-based record types. In FIG. 2, classes declared originally in a source code language 210 are expressed in the typed intermediate representation 115 at FIG. 1 as a class name-based type 220 that precisely refers to objects of the particular class name in the intermediate representation (e.g., 115 at FIG. 1). Each such precise class name in the intermediate representation 115 at FIG. 1 also has a corresponding structure-based record type 230 for expressing the structure-based information related to the layout associated with the class including its data fields, virtual methods, etc. Coercion functions 240 can be used to coerce between records of the structure-based record type 230 of a source-level class and objects of the class name-based type 220 of the class. For instance, if a particular data field needs to be accessed, then objects of the class name-based type 220 are coerced 240 to records of the corresponding structure-based record type 230 and the data field of interest is accessed via the records.

Keeping class name-based type information and its corresponding structure-based object layout information at the intermediate representation level has a low cost, because interesting work, such as field fetching, method invocation, and cast, is done on records types. Retaining a class name-based type and using a structure-based record type to express object layout in an intermediate representation simplifies a type system for the intermediate representation. First, structural recursive types are not necessary because each record type can refer to any class name, including the class to which the record type corresponds. Second, it simplifies the bounded quantification that is needed to express inheritance because the bounds for type variables can be specified in terms of sub-classing not sub-typing, as in traditional bounded quantification. Expressing the bounds in class names, as opposed to arbitrary structural types, results in decidable type checking.

### Exemplary Methods of Precise Expressions of Classes in a Typed Intermediate Language

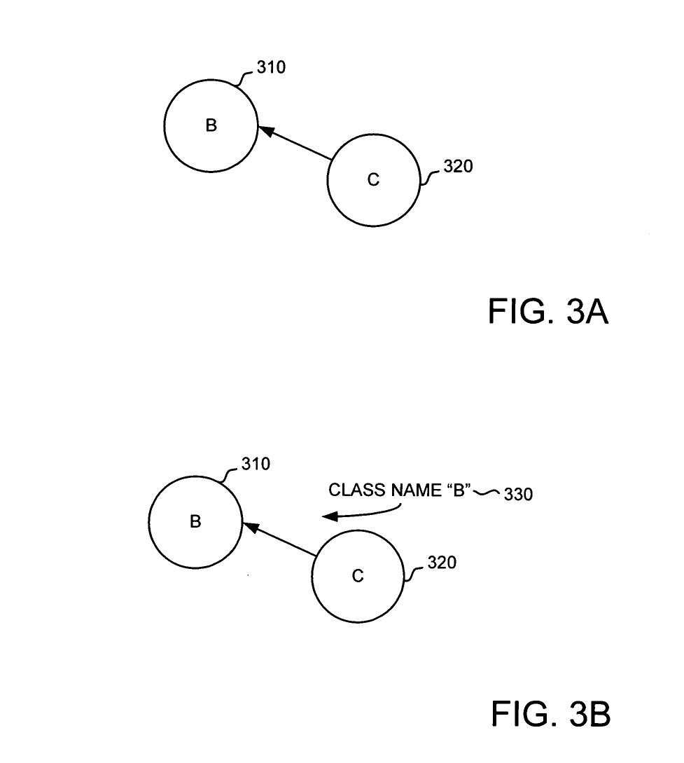

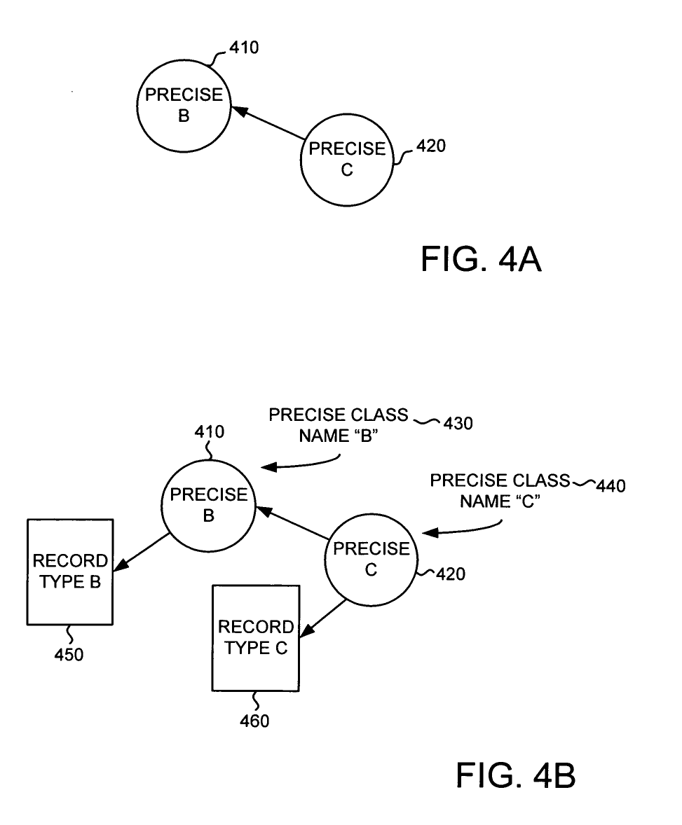

FIG. 3A illustrates class “B” 310 and class “C” at 320 in a source code representation 105 (FIG. 1) wherein, according to convention in object-oriented languages (e.g., C#, Java, or C++), a type with a class name of “B” 330 in FIG. 3B refers to objects of class “B” at 310 and any of its sub-classes, such as “C” at 320. However, in the typed intermediate representation 115 (FIG. 1), the class names have a precise notion. Thus, class names “B” and “C” at 410 and 420 (FIG. 4A) are retained in the typed intermediate representation 105 (FIG. 1), but the precise class name “B” at 430 (FIG. 4B) refers to objects of class “B” at 410, but not its sub-classes (e.g., “C” at 420). Likewise, precise class name “C” at 440 refers only to objects of type “C” at 420, but not any of its sub-classes (not shown). Such precise notions help in guaranteeing that operations, such as dynamic dispatch and type casts, are safe in the intermediate representation 105 (FIG. 1). Furthermore, as shown in FIG. 4B, each precise class named-based type is associated uniquely with a record type (e.g., 450 for the precise class name “B” 430 and 460 for the precise class name “C” 440).

### Exemplary Methods of Expressing Class Inheritances and Dynamic Types in a Typed Intermediate Language Inform of Sub-Classing Bounded Quantifications

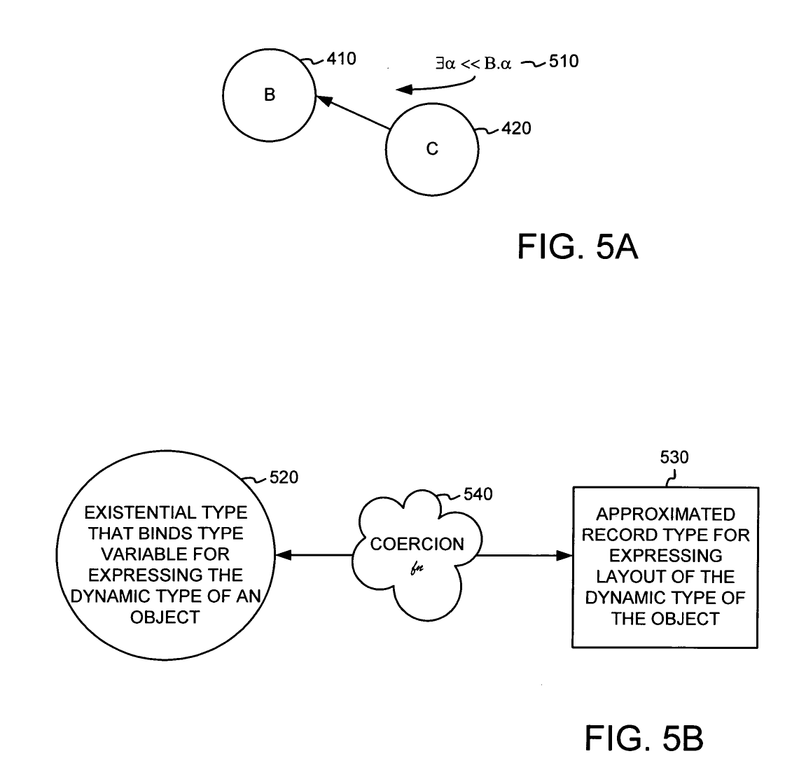

For at least some expressions, variables, and other parts of a program, the precise types of objects that the expressions, etc. may have at run time are unknown at compile time. This ambiguity surfaces, for example, when source code refers to a class at compile time, but the actual value at runtime is a subclass of the class. Typical source languages allow classes and subclasses to be used interchangeably, even though the precise type at run-time is dependent on the execution path which becomes evident only at runtime. The types of objects that the values of expressions, variables, and other code portions may have at runtime are called dynamic types. In the typed intermediate representation 115 (FIG. 1) provided with precise notions of class names, the loose reference of source code class names cannot be used to refer to the types of objects that are classes or their subclasses. Instead, as shown in FIG. 5A, in the intermediate representation, at 510 a bounded existential type ∃α<<B.α binds a type variable to indicate the dynamic type of an object whose type (e.g., 410 or 420) is not known at compile time. In this form, the type ∃α<<B.α is used to represent only the type of objects of class B or B's sub-classes. The type variable a, therefore, abstracts the dynamic type at compile time. To make type checking decidable, the typed intermediate representation 115 (FIG. 1) constrains the values attainable by the type variable (e.g., α) by placing sub-classing based bounds (e.g., as in α<<B) on the existential type variable. The bounding is made decidable because it is expressed in form of class names or other type variable names and not structure-based information, such as structure-based sub-typing bounds. For instance, the bounded existential type ∃α<<B.α with sub-classing bounds ensures that for type checking purposes it represents the dynamic types of objects such that the dynamic types can only be B or B's sub-classes.

The record types associated with class names also comprise a reference to the bounded existential types such as ∃α<<B.α with sub-classing bounded quantification in order to pack the “this” pointers of virtual methods within. For instance, suppose a class Point is declared as follows:

Class Point {
int x;
int distance ( ) {....}}

Provided the class declaration above, the exemplary class Point has an associated record type as follows:

```
R(Point) = {vtable : {tag :Tag(Point)
                distance : (∃α<< Point. α) → int },
        x : int}
```

Thus, the types of virtual methods refer to the dynamic types of their enclosing objects, such as (e.g., the method distance requires an object of type (∃α<<Point.α)) to ensure type safety even at the intermediate language level when the dynamic types of the objects are not certain. In this manner, a type variable (e.g., α) connects the object's dynamic type with the “this” pointer (e.g., of type ∃α<<Point.α) as in the record above. This is one manner by which type cast and dynamic dispatch are guaranteed safe.

Suppose class Point2D extends class Point as follows:

class Point2D : Point { int y;
int distance( ){. . .y . . .}}

The record type R(Point2D) will be as follows:

```
R(Point2D) = {vtable : {tag : Tag(Point2D),
                distance : (∃γ << Point2D. γ) → int},
        x : int, y : int}
```

The record type R(Point2D) includes members in Point, but it has its own tag and its own type for the “this” pointer (∃α<<Point2D.α).

As shown in FIG. 5B, a bounded existential type with sub-classing bounded quantification such as, ∃α<<B.α at 520, also has a corresponding structure-based approximated record-type at 530. The layout of an object of type ∃α<<B.α is approximated by a record that at least comprises all fields and methods declared in class “B.” An approximation coercion function 540 is provided to coerce between records of the approximated record type 530 and objects of the associated type variable at 520. The coercions are no-ops at runtime and, thus, introduce no overhead at runtime.

For instance, suppose an exemplary variable “O” has the bounded existential type ∃α<<Point.α (related to the class Point declared above), then “O” may at runtime have a value that is an object of class Point or any sub-class of Point. The layout of the dynamic types of objects that may be values of “O” at run-time can be approximated at compile time as follows:

```
ApproxR(α, Point) = {vtable : {tag : Tag(α),
                distance : (∃γ<<α.γ) →int},
        x^{M} : int }
```

Later on, if at runtime “O” happens to be assigned a value that is an object of class Point2D, which is declared above as sub-class of Point, then the precise record type of the object will be as follows:

```
    R(Point2D) = {vtable : {tag : Tag(Point2D),
                    distance : (∃γ << Point2D. γ) →
int},
            x : int, y : int}
```

Structural sub-typing can be enforced on the typed intermediate representation to ensure that the condition R(Point2D)≦ApproxR(α,Point)[Point2D/α] holds. The two functions R(C) and ApproxR(α, C) need to have knowledge of the layout the compiler chooses for objects. Therefore, the layout information is part of the type system. However, not all typing rules need use the two functions. Thus, the rest of the type system can be independent of the layout strategy. The soundness of the type system only requires that:

(1) ApproxR(α,C) ≦ ApproxR(α,B) if C << B; and
(2) R(C) ≦ ApproxR(α,B)[C/α] if C << B.

### An Exemplary Syntax of Types in the Exemplary Intermediate Representation

Based on the descriptions above of a type intermediate representation wherein class name-based information related to classes are retained, at least some types for such a typed intermediate representation are as follows:

τ = int | C | α| array (τ)
|∀α << τ.τ′ | ∃α<< τ.τ′ | (τ_{1,} ... , τₙ) → τ
| {l₁^{φ1} : τ₁, ..., lₙ^{φn} : τₙ} | {{ l₁^{φ1} : τ₁, ..., lₙ^{φn} : τₙ}}

The standard types include integer type int, type variables α, array types array (τ), function types (τ₁, . . . , τₙ)→τ and record types (l₁^{φ1}:τ₁, . . . , lₙ^{φn}:τₙ}. The non-standard types are precise class names “C”, bounded quantified types including universal types such as ∀α<<τ.τ and existential types ∃α<<τ.τ. The precise class names have corresponding precise record types which are denoted by the brackets {{and}}. For instance, the type R(C) for class name “C” is a precise record type and as such, the associated vtable has a precise record type that excludes fields in addition to those declared precisely in the class declaration for class “C”. Type {{l₁^{φ1}:τ₁, . . . , lₙ^{φn}:τₙ}} is a sub-type of {l₁^{φ1}:τ₁, . . . , lₙ^{φn}:τₙ} and therefore values of record type {{l₁^{φ1}:τ₁, . . . , lₙ^{φn}:τₙ}} can be used wherever values of record type {l₁^{φ1}:τ₁, . . . , lₙ^{φn}:τₙ} are called for.

### Exemplary Syntax for Expressing Values and Expressions in the Exemplary Typed Intermediate Representation

Based on the syntax described above for the type intermediate representation, at least some of the values and expressions in the typed intermediate representation are as follows:

| | |
|---|---|
| e ::= | \| x \| n \| l \| C(e) \| c2r(e) \| error [τ] |
| | \|new [τ] {lᵢ = eᵢ} ⁿᵢ₌₁ \| e.l \| e₁.lᵢ := e₂ in e₃ |
| | \|new [e₀, ... ..., eₙ₋₁]^{τ}\| e₁[e₂] e₁[e₂] := e₃ in e₄ |
| | \|x : τ = e₁ in e₂ \| x := e₁ in e₂ |
| | \| e [τ₁, ...., τₘ] (e₁, ..., eₙ) |
| | \| pack τ as α<< τᵤ in (e : τ′) |
| | \| (α, x) = open(e₁) in e₂ |

The typed intermediate representation has word-size values including but not limited to integer literal n, label l as a pointer to a value on the heap. Expression C(e) coerces a record labeled by e to an object of the precise class name “C” (e.g., as described above with reference to FIGS. 4A-B). The expression c2r(e) coerces an object e to a record (e.g., as described above with reference to FIGS. 4A-B). Expression error [τ] represents runtime errors, such as cast failures. A type checker will expect a value of type τ, if no errors happen. Values that cannot fit into a word are allocated on the heap, including records, arrays, and functions. The notation “:=” stands for an assignment. The expressions of form new [τ] {lᵢ=eᵢ}ⁿᵢ₌₁|e.l|e₁.lᵢ:=e₂ in e₃ relate to records of type τ and labeling of record fields. For instance, e₁.lᵢ:=e₂ assigns a new value to a record field. The expressions of form “new [e₁, . . . eₙ₋₁]^{τ}|e₁[e₂]|e₁[e₂]:=e₃ in e₄” relate to arrays of type τ. The sub expression “e₁[e₂]:=e₃” assigns a new value of e₃ to an array element represented by “e₁[e₂].”

The expression “e [τ₁, . . . τₘ] (e₁, . . . , eₙ)” relates to a method call. The values “(e₁, . . . , eₙ)” represent arguments and the “[τ₁, . . . , τₘ]” represent type arguments of the polymorphic method e. The expression “x:τ=e₁ in e₂” relates to introduction of a new local variable of type τ and initializes the value to e₁ to be used in the expression e₂. The existential pack operation of “pack τ as α<<τᵤ in (e:τ′)” relates to introduction of an existential type comprising a type variable with sub-classing bounds. The expression “(α, x)=open (e₁) in e₂” opens access to a value of an existential type.

### Exemplary Static Semantics of the Typed Intermediate Representation

The typed intermediate representation maintains a class declaration table as Θ that maps class names to class declarations. The class declaration part of the program can serve as such a table. The kind environment Δ tracks type variables in their scope and their bounds. Each entry in Δ introduces a new type variable and an upper or lower bound of the type variable. As noted above, the bound is a class name or another type variable introduced previously in Δ, a heap environment Σ maps labels to types. A type environment Γ maps variables to types. Mutable variables (those introduced by “let” expressions) are marked in Γ.x:_{M}τ means x is mutable. The substitution “τ/α” refers to replacing α with τ. The static semantics listed above are referred to the typing rules discussed below to refer to various environments.

### Exemplary Semantics of Sub-Classing Rules and Sub-Typing Rules in the Exemplary Typed Intermediate Representation

In addition to the notion of sub-classing as denoted by “<<” relationship between classes, the intermediate representation also has structural sub-typing, represented by the “≦” relationship. The sub-typing relation is reflexive and transitive. Record types have breadth sub-typing and depth sub-typing on immutable fields. According to breadth sub-typing, adding more fields to a record type creates a subtype. The super type is a prefix of the sub-type. Specializing immutable field types leads to depth sub-typing. Depth sub-typing is excluded on mutable fields to preserve soundness. The label order in a record type (e.g., new [τ] {lᵢ=eᵢ}ⁿᵢ₌₁) is significant because the fields represent physical layout of data. As noted above with respect to approximated record types, in the typed intermediate representation, record sub-typing is used to approximate the layout of an object whose “exact” type is unknown at compile time. For instance, a dynamic type of object “O” can be approximated at compile time as follows:

```
ApproxR(α, Point) = {vtable : {tag : Tag(α),
                distance : (∃γ<<α.γ) →int},
        x^{M} : int }
```

Bounded quantified types have sub-typing. A frequently used rule is as follows:
(∃α<<C.α)≦(∃α<<B.α) if C<<B

Thus, in this manner, sub-typing at the low level typed intermediate representation is connected to sub-classing. The rule can be used for inheritance subsumption. For instance, if C<<B and a variable “O” has type ∃α<<C.α, then “O” can be used wherever an object of class B or B's subclasses (e.g., represented by type ∃α<<B.α) is expected. In the typed intermediate representation, safe inherited method implementation is possible. For instance, a sub-class can inherit a method implementation from its super classes. Suppose class C is a sub-class of “B” (e.g., as C<<B). The “this” pointer of methods in the record type associated with C has an existential type with sub-classing bounds, which is ∃α<<C.α. The “this” pointer of methods in B has existential type with sub-classing bounds, which is ∃α<<B.α. Because C<<B, then (∃α<<C.α)≦(∃α<<B.α). Thus, a function that takes a parameter of type ∃α<<B.α can be used as one with a parameter of type ∃α<<C.α, that is, C can use B's method implementation.

However, sub-classing is different from sub-typing. If C<<B and C and B are different classes with precise class names, then C is not a subtype of B, and neither is R(C) a subtype of R(B), because C represents objects of precise class name C and R(C) describes the precise layout of those objects. Thus, in the typed intermediate representation an object of precise C cannot be used where an object of precise B is needed.

At least some of the typing rules for the type checker with respect to type checking sub-classing relationships of a typed intermediate representation are as follows: (rules are expressed herein in terms of one or more premises expressed with respect to one or more environments in the nominator, which if true, allows for the type checking conclusion noted below as the denominator to be true)

$$\frac{Θ ( C ) = C \text{:} B \{ … \}}{Θ \text{:} Δ ⊢ C ⪡ B} \frac{Θ ; Δ ⊢ τ \text{:} {Ω}_{c}}{Θ ; Δ ⊢ τ ⪡ Topc} \frac{α ⪡ τ ∈ Δ}{Θ ; Δ ⊢ α ⪡ τ} \frac{α ⪢ τ ∈ Δ}{Θ ; Δ ⊢ τ ⪡ α} \frac{Θ ; Δ ⊢ τ \text{:} {Ω}_{c}}{Θ ; Δ ⊢ τ ⪡ τ} \frac{Θ ; Δ ⊢ {τ}_{1} ⪡ {τ}_{2} Θ ; Δ ⊢ {τ}_{2} ⪡ {τ}_{3}}{Θ ; Δ ⊢ {τ}_{1} ⪡ {τ}_{3}}$$

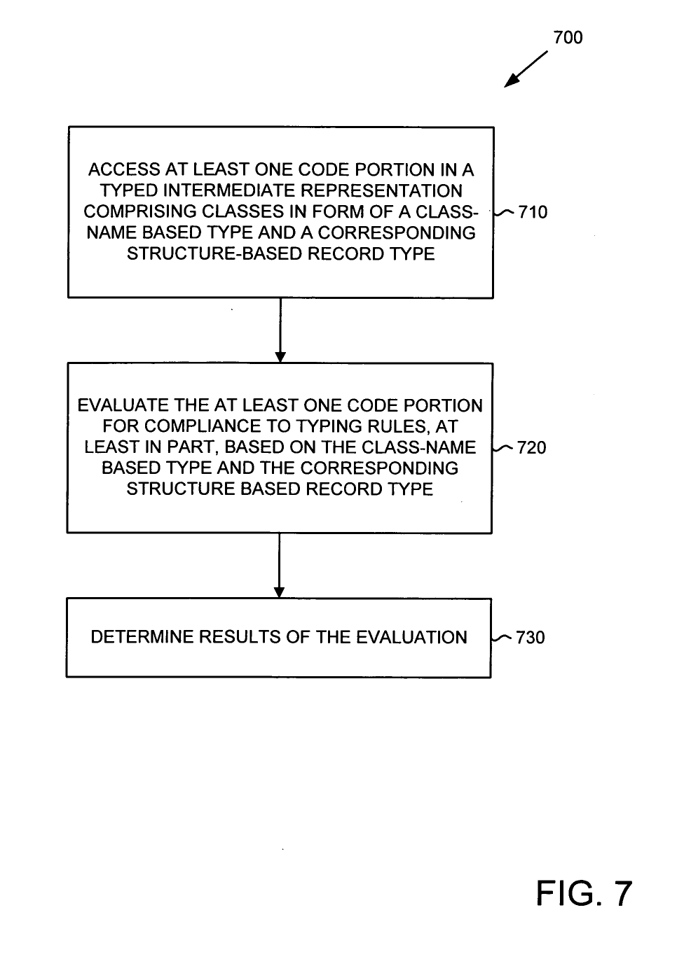

The rules as expressed above and from hereon are just one set of embodiments of one set of representations of the actual rules that can be applied in a computer program implementing a type checking algorithm, such as the one described below with reference to FIG. 7. Other embodiments and other representations of the typing rules that apply principles expressed with reference to these rules are also possible. For instance, notations, operands and operators of the rules may be changed in form without deviating from the principles expressed therein.

From among the rules above, the sub-classing judgment Θ;Δ├τ₁<<τ₂ means that under environments Θ and Δ, τ₁ is a sub-class of τ₂, which if true and if τ₂<<τ₃ is also true then τ₁<<τ₃ is also true.

At least some of the sub-typing related rules for the type checker are as follows:

$$\frac{m \geq n}{Θ ; Δ ⊢ {\{ {l}_{i}^{{ϕ}_{i}} \text{:} {τ}_{i} \}}_{i = 1}^{m} \leq {\{ {l}_{i}^{{ϕ}_{i}} \text{:} {τ}_{i} \}}_{i = 1}^{n}} st\_breadth$$

$$\frac{∀ 1 \leq i \leq m , \{ \begin{matrix}Θ ; Δ ⊢ {τ}_{i} \leq {τ}_{i}^{′} & if {ϕ}_{i} = I \\ {τ}_{i} = {τ}_{i}^{′} & if {ϕ}_{i} = M\end{matrix}}{Θ ; Δ ⊢ {\{ {l}_{i}^{{ϕ}_{i}} \text{:} {τ}_{i} \}}_{i = 1}^{m} \leq {\{ {l}_{i}^{{ϕ}_{i}} \text{:} {{τ}^{′}}_{i} \}}_{i = 1}^{m}} st\_depth$$

$$\frac{}{Θ ; Δ ⊢ {\{ \{ {l}_{i}^{{ϕ}_{i}} \text{:} {τ}_{i} \} \}}_{i = 1}^{m} \leq {\{ {l}_{i}^{{ϕ}_{i}} \text{:} {τ}_{i} \}}_{i = 1}^{m}} st\_exact$$

$$\frac{Θ ; Δ ⊢ {t}_{i} \leq {s}_{i} ∀ 1 \leq i \leq n Θ ; Δ ⊢ s \leq t}{Θ ; Δ ⊢ ( {s}_{1} , … , {s}_{n} ) \to s \leq ( {t}_{1} , … , {t}_{n} ) \to t} st\_fun$$

$$\frac{Θ ; Δ ⊢ {u}_{1} ⪡ {u}_{2} Θ ; Δ , α ⪡ Topc ⊢ {τ}_{1} \leq {τ}_{2}}{Θ ; Δ ⊢ ( ∃ α ⪡ {u}_{1} \cdot {τ}_{1} ) \leq ( ∃ α ⪡ {u}_{2} \cdot {τ}_{2} )} st\_exists$$

$$\frac{Θ ; Δ ⊢ {u}_{2} ⪡ {u}_{1} Θ ; Δ , α ⪡ Topc ⊢ {τ}_{1} \leq {τ}_{2}}{Θ ; Δ ⊢ ( ∀ α ⪡ {u}_{1} \cdot {τ}_{1} ) \leq ( ∀ α ⪡ {u}_{2} \cdot {τ}_{2} )} st\_forall$$

$$\frac{}{Θ ; Δ ⊢ τ \leq τ} st\_ref$$

$$\frac{Θ ; Δ ⊢ {τ}_{1} \leq {τ}_{2} Θ ; Δ ⊢ {τ}_{2} \leq {τ}_{3}}{Θ ; Δ ⊢ {τ}_{1} \leq {τ}_{3}} st\_trans$$

The sub-typing rule for existential types with sub-classing bounds “st_exists,” as noted above, at least in part states that provided u₁<<u₂ and τ₁≦τ₂ with α introduced to the environment then (∃α<<u₁.τ₁)≦(∃α<<u₂.τ₂) is also true. Similarly, universal types have the rule “st_forall” as noted above, wherein if u₂<<u₁ and τ₁≦τ₂ with α introduced to the environment, then it is also true that (∀α<<u₁.τ₁)≦(∀α<<u₂.τ₂). The use of sub-classing bounds in quantified types as opposed to sub-typing bounds leads to decidable subtyping, and therefore decidable type checking.

### Exemplary Semantics for Typing Rules for Type Checking Related to Expressions in the Typed Intermediate System

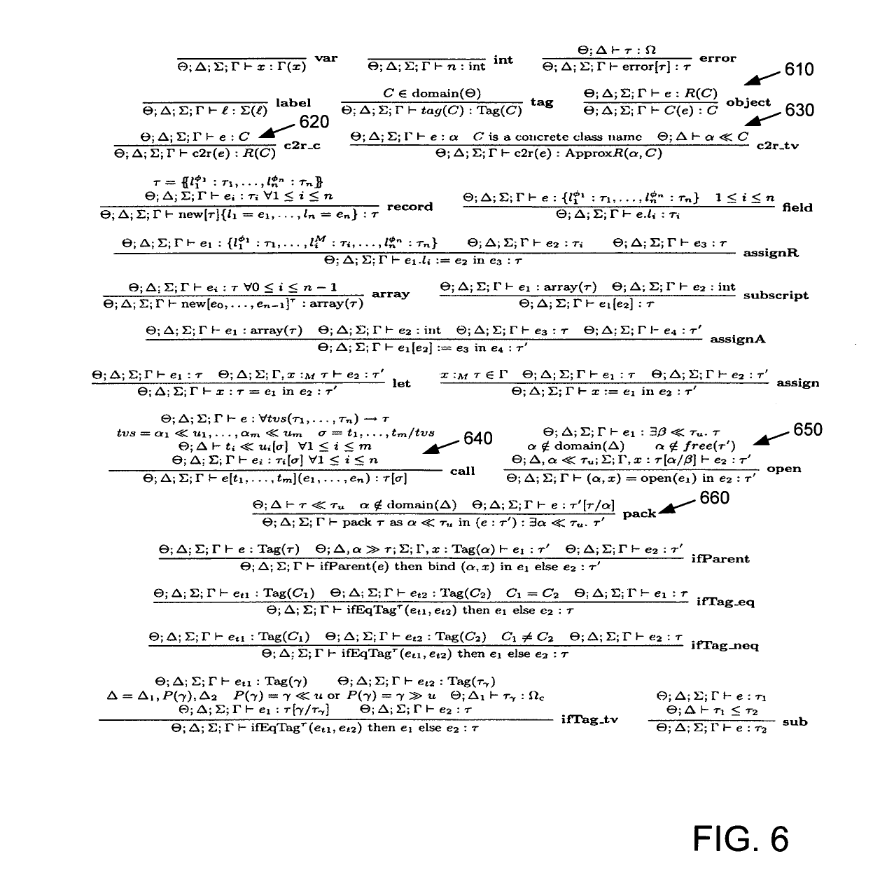

FIG. 6 illustrates an exemplary embodiment of an exemplary set of rules related to at least some expressions and sub-expressions thereof in the typed intermediate representation. The rules can be used for type checking to ensure type safety of the intermediate representation. As noted above, the typing rules described herein are not limited in any of their aspects by the notation chosen to express such rules. Other notations are possible. The “object” rule at 610 in FIG. 6 states, at least in part, that suppose an expression “e” is of record type R(C) then it is also true that the coercion expression “C(e)” for coercing a record to an object has a precise class name “C.” The “c2r_c” rule at 620 states, at least in part, that suppose an expression “e” is of type precise class name “C” then “c2r(e)” yields a record of type “R(C).”

The “c2r_tv” rule at 630 relates to type checking coercion expressions of objects whose dynamic types are unknown at compile time. The rule at 630 states, at least in part, that suppose in one environment “e” is of a type variable “α,” class name “C” is a concrete class and further if the type variable is bounded by a sub-classing bound as “α<<C”, then it is true that the coercion “c2r(e)” yields a record of type “ApproxR(α,C).” As described above, the “ApproxR(α,C)” is an approximated record type for a dynamic type expressed as a type variable with a sub-classing bound “α<<C.” As such, the approximation of the record type would be based on the known class type “C” that is in the associated sub-classing bound.

The typing rule for the “call” expression at 640, at least in part, allows for type checking of functions and the arguments they accept by, at least in part, using sub-classing bounded type variables. Thus, according to the “call” rule at 640, if the method “e” is declared with type variables “tvs,” formal types (τ₁, . . . , τₙ) and a result of type “τ” then “τ” and (τ₁, . . . , τₙ) might comprise type variables in “tvs.” In “tvs”, the type variables are constrained with sub-classing bounds as “tvs=α<<u₁, . . . , αₘ<<uₘ.” Further with substitutions, such as σ=t₁, . . . , tₘ/tvs, the actual types t₁, . . . , tₘ are also verified in terms of the sub-classing bounds as tᵢ<<uᵢ[σ] for all 1≦i≦m, which leads to a conclusion in part that the method call e[t₁, . . . , tₘ] (e₁, . . . eₙ) is of type τ[σ].

The “pack” expression at 660 (FIG. 6) introduces an existential type and the “open” expression at 650 opens or in other words eliminates an existential type. Thus, according to the typing rule listed at 650, the expression (α, x)=open (e₁) in e₂ can be concluded to have type τ′ where (e₁) has existential type ∃β<<τᵤ.τ provided that e₂ has type τ′ with α<<τᵤ and variable x has type τ[α/β].

Furthermore, according to the typing rule 660, type checking the “pack” expression also comprises checking existential types. For instance, suppose τ is some class such that τ is a sub-class of another class τᵤ (τ<<τᵤ) then if some expression e has type τ′ with substitution τ/α, then the expression “pack τ as α<<τᵤ in (e:τ′)” has the existential type ∃α<<τᵤ.τ′.

### An Exemplary Method for Type Checking a Exemplary Typed Intermediate Representation

FIG. 7 illustrates an exemplary method 700 implemented by a type checker (e.g., 120 in FIG. 1) for applying typing rules (e.g., 130) in order to evaluate the type safety of the intermediate representation (e.g., 115). At 710, for instance, the type checker accesses code portions in a typed intermediate representation of a computer program compiled from its source code representation in an object-oriented language (e.g., C#, C++and Java). The typed intermediate representation (e.g., 115) comprises classes in the form of class name-based types and structure based record types. Thus, type checking based on both sub-classing and sub-typing are possible in the typed intermediate representation. As noted above, typing rules comprising sub-classing based on class-names are decidable, whereas the general rules relying entirely on sub-typing are not.

Typing rules related to code portions such as expressions can be based on both sub-classing relationships of classes and sub-typing relationships of types. Dynamic types are abstracted at compile time for type checking based on an existential type comprising a type variable with sub-classing bounds. At least, some of these rules are described above with reference to FIG. 6 and are based in part on the sub-classing rules and sub-typing rules described above. At 720, such typing rules are applied to evaluate the type safety of at least one code portion of the typed intermediate representation. Later at 730, once the type safety evaluation of the code portion is complete, the results of the evaluation are determined.

### Exemplary Computing Environment

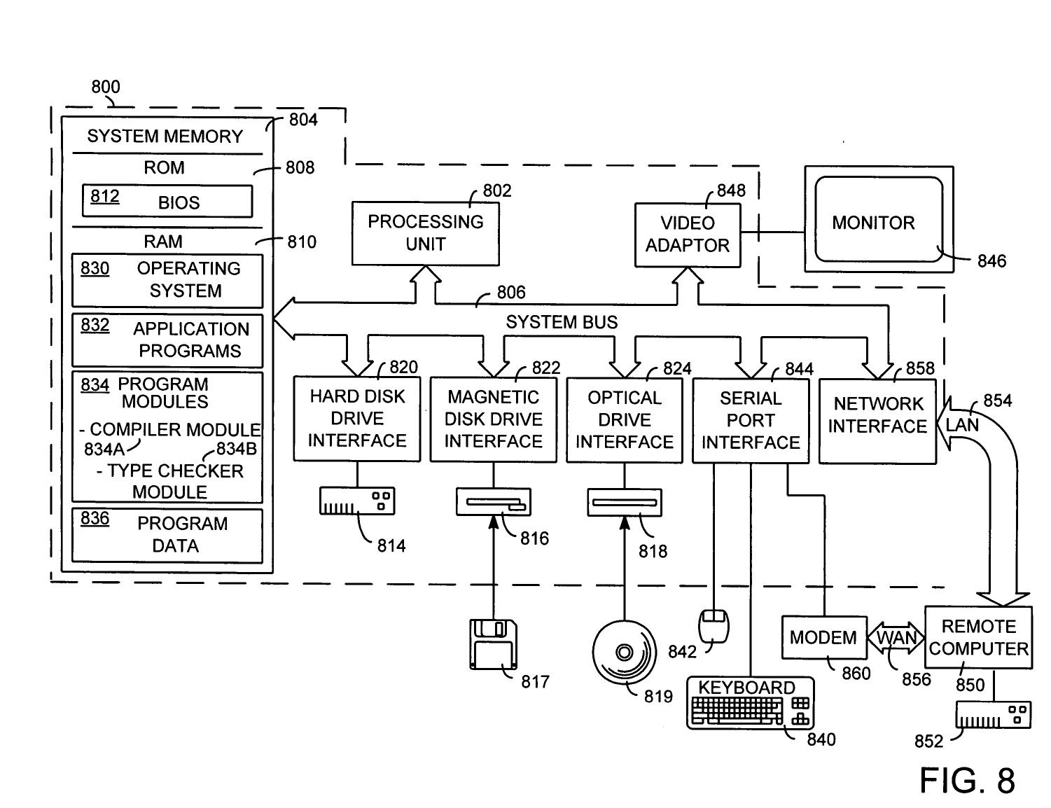

FIG. 8 and the following discussion are intended to provide a brief, general description of an exemplary computing environment in which the disclosed technology may be implemented. Although not required, the disclosed technology was described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 8, an exemplary system for implementing the disclosed technology includes a general-purpose computing device in the form of a conventional PC 800, including a processing unit 802, a system memory 804, and a system bus 806 that couples various system components including the system memory 804 to the processing unit 802. The system bus 806 may be any of several types of bus structures including a memory bus or memory controller, a peripheral bus, and a local bus using any of a variety of bus architectures. The system memory 804 includes read only memory (ROM) 808 and random access memory (RAM) 810. A basic input/output system (BIOS) 812, containing the basic routines that help with the transfer of information between elements within the PC 800, is stored in ROM 808.

The PC 800 further includes a hard disk drive 814 for reading from and writing to a hard disk (not shown), a magnetic disk drive 816 for reading from or writing to a removable magnetic disk 817, and an optical disk drive 818 for reading from or writing to a removable optical disk 819 (such as a CD-ROM or other optical media). The hard disk drive 814, magnetic disk drive 816, and optical disk drive 818 are connected to the system bus 806 by a hard disk drive interface 820, a magnetic disk drive interface 822, and an optical drive interface 824, respectively. The drives and their associated computer-readable media provide nonvolatile storage of computer-readable instructions, data structures, program modules, and other data for the PC 800. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored on the hard disk 814, magnetic disk 817, optical disk 819, ROM 808, or RAM 810, including an operating system 830, one or more application programs 832, other program modules 834, and program data 836. Furthermore, the program modules 834 may comprise a compiler module 834A and a type checker module 834B. A user may enter commands and information into the PC 800 through input devices such as a keyboard 840 and pointing device 842 (such as a mouse). Other input devices (not shown) may include a digital camera, microphone, joystick, game pad, satellite dish, scanner, or the like. These and other input devices are often connected to the processing unit 802 through a serial port interface 844 that is coupled to the system bus 806, but may be connected by other interfaces such as a parallel port, game port, or universal serial bus (USB). A monitor 846 or other type of display device is also connected to the system bus 806 via an interface, such as a video adapter 848. Other peripheral output devices, such as speakers and printers (not shown), may be included.

The PC 800 may operate in a networked environment using logical connections to one or more remote computers, such as a remote computer 850. The remote computer 850 may be another PC, a server, a router, a network PC, or a peer device or other common network node, and typically includes many or all of the elements described above relative to the PC 800, although only a memory storage device 852 has been illustrated in FIG. 8. The logical connections depicted in FIG. 8 include a local area network (LAN) 854 and a wide area network (WAN) 856. Such networking environments are commonplace in offices, enterprise-wide computer networks, intranets, and the Internet.

When used in a LAN networking environment, the PC 800 is connected to the LAN 854 through a network interface 858. When used in a WAN networking environment, the PC 800 typically includes a modem 860 or other means for establishing communications over the WAN 856, such as the Internet. The modem 860, which may be internal or external, is connected to the system bus 806 via the serial port interface 844. In a networked environment, program modules depicted relative to the PC 800, or portions thereof, may be stored in the remote memory storage device (not shown). The network connections shown are exemplary, and other means of establishing a communications link between the computers may be used.

### Alternatives

Having described and illustrated the principles of our invention with reference to the illustrated embodiments, it will be recognized that the illustrated embodiments can be modified in arrangement and detail without departing from such principles. For instance, many examples of the typed intermediate representations and typing rules for type checking such representation are expressed in form of various notations. However, these notations are merely representative of the principles expressed therein and other notations are possible. Although the rules are expressed as formulas and expressions in selected forms above, a computing tool implementing the methods described above may store the actual rules in many different forms including a digital representation.

The rules, described herein are meant to be illustrative of rules needed to implement a type system. However, other rules can be formulated based on the principles and methods described herein according to the needs of particular systems and programming languages.

Elements of the illustrated embodiment shown in software may be implemented in hardware and vice versa. Also, the technologies from any example can be combined with the technologies described in any one or more of the other examples. In view of the many possible embodiments to which the principles of the invention may be applied, it should be recognized that the illustrated embodiments are examples of the invention and should not be taken as a limitation on the scope of the invention. For instance, various components of systems and tools described herein may be combined in function and use. We therefore claim as our invention all subject matter that comes within the scope and spirit of these claims.

We claim:

1. A computer implemented method for type checking a typed intermediate representation of a computer program, the method comprising:
accessing at least one code portion of the typed intermediate representation of a computer program, wherein the typed intermediate representation comprises one or more code portions that are typed based on class name-based types and the corresponding structure-based record types; and
evaluating type safety of the at least one code portion of the typed intermediate representation by applying typing rules based on the class name-based types and the corresponding structure-based record types.

2. The method of claim 1, wherein the typing rules comprise at least one rule connecting sub-classing to sub-typing wherein if a first class is a sub-class of a second class then a first existential type comprising a first type variable with a first sub-classing bound comprising a first precise class name of the first class is a sub-type of a second existential type comprising a second type variable with a second sub-classing bound comprising a second precise class name of the second class.

3. The method of claim 1, wherein the typing rules comprise at least one rule related to an expression comprising a coercion from a first expression of one of the structure-based record types to a second expression of one of the corresponding class name-based types, the rule comprising a condition that if the first expression is known to be of the one of the structure-based record types then the coercion yields the second expression of the one of the corresponding class name-based types.

4. The method of claim 1, wherein the typing rules comprise at least one rule related to an expression comprising a coercion from a first expression of one of the class name-based types to a second expression of one of the corresponding structure-based record types, the rules comprising a condition that if the first expression is known to be of the one of the class name-based types then the coercion yields the second expression of the one of the corresponding structure-based record types.

5. The method of claim 1, wherein the typing rules comprise at least one rule related to an expression comprising a coercion from a first expression of a type variable with sub-classing bounds to a second expression of a corresponding approximated record type, the rule comprising a condition that if the sub-classing bounds comprise a first precise class name then the coercion yields the second expression of the corresponding approximated record type based at least in part on a first precise record type associated with the first precise class name.

6. The method of claim 1, wherein the typing rules comprise at least one rule for type checking an expression comprising method calls, the rule including one or more type check conditions for types of value arguments and one or more type check conditions for bounds of type arguments associated with the method calls wherein the type check conditions for the type arguments are based on sub-classing bounds.

7. The method of claim 6, wherein the sub-classing bounds are in form of precise class names.

8. The method of claim 6, wherein the sub-classing bounds are in form of other type variables.

9. The method of claim 1, wherein the typing rules comprise at least one rule for type checking expressions comprising one or more existential open sub-expressions, the rule including one or more type check conditions comprising one or more type variables associated with the one or more open sub-expressions wherein the type check conditions are based on sub-classing bounds applied to the one or more type variables.

10. The method of claim 9, wherein the sub-classing bounds are in form of precise class names.

11. The method of claim 9, wherein the sub-classing bounds are in form of other type variables.

12. The method of claim 1, wherein the typing rules comprise at least one rule for type checking expressions comprising one or more existential pack sub-expressions, the rule including one or more type check conditions comprising one or more type variables associated with the one or more pack sub-expressions wherein the type check conditions are based on sub-classing bounds applied to the one or more type variables.

13. The method of claim 12, wherein the sub-classing bounds are in form of precise class names.

14. The method of claim 12, wherein the sub-classing bounds are in form of other type variables.

15. At least one computer-readable medium having stored thereon instructions for executing a method of type checking a typed intermediate representation of a computer program, the instructions comprising typing rules for type checking one or more code portions of the intermediate representation based on a source code representation of the computer program wherein the one or more code portions of the typed intermediate representation are typed based on class name-based types and the corresponding structure-based record types.

16. The at least one computer-readable medium of claim 15 wherein the typing rules comprise at least one rule connecting sub-classing to sub-typing, the at least one rule implying (∃α<<C.α)≦(∃α<<B.α) if C<<B.

17. The at least one computer-readable medium of claim 15 wherein the typing rules comprise at least one rule related to an expression comprising a coercion from a first expression of one of the structure-based record types to a second expression of one of the corresponding class name-based types, wherein the at least one rule is as follows:
$$\frac{Θ ; Δ ; \sum ; Γ ⊢ e \text{:} R ( C )}{Θ ; Δ ; \sum ; Γ ⊢ C ( e ) \text{:} C} object$$

18. The at least one computer-readable medium of claim 15 wherein the typing rules comprise at least one rule related to an expression comprising a coercion from a first expression of one of the class name-based types to a second expression of one of the corresponding structure based record types, wherein the at least one rule is as follows:
$$\frac{Θ ; Δ ; \sum ; Γ ⊢ e \text{:} C}{Θ ; Δ ; \sum ; Γ ⊢ c 2 r ( e ) \text{:} R ( C )} c2r\_c$$

19. The at least one computer-readable medium of claim 15 wherein the typing rules comprise at least one rule related to an expression comprising a coercion from a first expression of a dynamic type expressed in form of type variables with sub-classing bounds to a second expression of a corresponding approximated record type wherein the at least one rule is as follows:
$$\frac{Θ ; Δ ; \sum ; Γ ⊢ e \text{:} α C is a concrete name Θ ; Δ ⊢ α << C}{Θ ; Δ ; \sum ; Γ ⊢ c 2 r ( e ) \text{:} Approx R ( α , C )} c2r\_tv$$

20. The at least one computer-readable medium of claim 15 wherein the typing rules comprise at least one rule related to an expression comprising a method call, wherein the at least one rule is as follows:
$$\frac{\begin{matrix}\begin{matrix}\begin{matrix}Θ ; Δ ; \sum ; Γ ⊢ e \text{:} ∀ tvs ( {τ}_{1} , … , {τ}_{n} ) \to τ \\ tvs = {α}_{1} << {u}_{1} , … , {α}_{m} << {u}_{m} σ = {t}_{1} , … , {t}_{m} / tvs\end{matrix} \\ Θ ; Δ ⊢ {t}_{i} << {u}_{i} [ σ ] ∀ 1 \leq i \leq m\end{matrix} \\ Θ ; Δ ; \sum ; Γ ⊢ {e}_{i} \text{:} {τ}_{i} [ σ ] ∀ 1 \leq i \leq n\end{matrix}}{Θ ; Δ ; \sum ; Γ ⊢ [ {t}_{1} , … , {t}_{m} ] ( {e}_{1} , … , {e}_{n} ) \text{:} τ [ σ ]} call$$

21. The at least one computer-readable medium of claim 15 wherein the typing rules comprise at least one rule related to an expression comprising a open sub-expression, wherein the at least one rule is as follows:
$$\frac{\begin{matrix}\begin{matrix}Θ ; Δ ; \sum ; Γ ⊢ e \text{:} ∃ β 〈 〈 {τ}_{u} \cdot τ \\ α ∉ domain ( Δ ) α ∉ free ( {τ}^{′} )\end{matrix} \\ Θ ; Δ , α 〈 〈 τ u ; \sum ; Γ , x \text{:} τ [ α / β ] ⊢ {e}_{2} \text{:} {τ}^{′}\end{matrix}}{Θ ; Δ ; \sum ; Γ ⊢ ( α , x ) = open ( {e}_{1} ) {ine}_{2} \text{:} {τ}^{′}} open$$

22. The at least one computer-readable medium of claim 15 wherein the typing rules comprise at least one rule related to an expression comprising a pack sub-expression, wherein the at least one rule is as follows:
$$\frac{Θ ; Δ ⊢ τ << {τ}_{u} α << domain ( Δ ) Θ ; Δ ; \sum ; Γ ⊢ e \text{:} {τ}^{′} [ τ / α ]}{ Θ ; Δ ; \sum ; Γ ⊢ pack τ as α << {τ}_{u} in ( e \text{:} {τ}^{′} ) \text{:} ∃ α << {τ}_{u} \cdot {τ}^{′}} pack$$

23. A computer system for type checking a typed intermediate representation of a computer program, the computer system comprising:
a type checker operable for accessing at least one code portion of the typed intermediate representation of the computer program wherein the typed intermediate representation comprises one or more code portions that are typed in form of class name-based types and corresponding structure-based record types.
